(19) United States
(12) Patent Application Publication
(10) Pub. No.: US 2026/0135238 A1
(43) Pub. Date: May 14, 2026

(54) CELL PACK

(71) Applicant: Prime Planet Energy & Solutions, Inc., Tokyo (JP)

(72) Inventors: Takashi INAMURA, Himeji-shi (JP); Takatoshi KAGEYAMA, Kakogawa-shi Hyogo-ken (JP)

(21) Appl. No.: 19/373,722

(22) Filed: Oct. 30, 2025

(30) Foreign Application Priority Data
Nov. 8, 2024 (JP) 2024-196163

(51) Int. Cl. H01M 50/298; H01M 10/6556; H01M 50/209; H01M 50/233; H01M 50/271; H01M 50/284; H01M 50/296; H01M 50/507; H01M 50/51; H01M 50/569; H01M 50/588

(52) U.S. Cl. CPC H01M 50/298; H01M 10/6556; H01M 50/209; H01M 50/233; H01M 50/271; H01M 50/284; H01M 50/296; H01M 50/507; H01M 50/51; H01M 50/569; H01M 50/588

(57) ABSTRACT

A cell pack includes cells, bus bars, a first collective terminal bus bar, a second collective terminal bus bar, a junction box, a pack case, a harness assembly, a refrigerant flow passage, a temperature sensor, and a temperature detection cable. The first collective terminal bus bar extends toward the junction box from a location near a first corner portion. The temperature sensor is disposed at a position of a bottom wall that is away from a junction box accommodating space. The temperature detection cable is wired along a wiring route that is set so as to extend along one of the side walls from a position at which the temperature sensor is disposed, in a region above a cell accommodating space while avoiding the harness assembly, and to extend toward the junction box accommodating space while inwardly avoiding a first corner portion.

The present application claims priority from Japanese Patent Application No. 2024-196163 filed on Nov. 8, 2024, which is incorporated by reference herein in its entirety.

### BACKGROUND

The present disclosure relates to a cell pack.

JP 2013-125612 A discloses a battery pack including a module group, a voltage detection line, and a temperature detection line. The module group includes a plurality of stacked single cells and is formed in a box shape. The voltage detection line measures a voltage of the single cells in the module. The temperature detection line measures a temperature of the single cells in the module. A main surface of the module side surfaces, in which a current line is wired to be longest, is provided with a current line that is parallel to one of the sides that forms the main surface. A voltage detection line portion that is parallel to the current line and a temperature detection line portion that is parallel to the current line are disposed in a surface other than the main surface. It is stated that such a battery pack is able to eliminate adversely effects of electromagnetic noise resulting from the current line. It is also stated to be capable of voltage detection and temperature detection with high accuracy.

JP 2023-124438 A discloses a cell pack in what is called a cell-to-pack structure, in which a plurality of cells are housed directly in a pack case.

### SUMMARY

In the cell pack in a cell-to-pack structure, the housed contents are arranged without gaps inside the pack case in order to increase the energy density. For this reason, the housed contents and the wiring lines may interfere with each other inside the pack case.

According to the present disclosure, a cell pack includes a plurality of cells, a plurality of bus bars, a first collective terminal bus bar, a second collective terminal bus bar, a junction box, a pack case, a harness assembly, a refrigerant flow passage, a temperature sensor, and a temperature detection cable. Each of the plurality of cells includes an electricity storage device. The plurality of bus bars connects the plurality of cells in series. The first collective terminal bus bar is connected to a first collective terminal that is an electrical terminal end of the plurality of cells connected in series. The second collective terminal bus bar is connected to a second collective terminal that is an electrical terminal end of the plurality of cells connected in series. To the junction box, the first collective terminal bus bar and the second collective terminal bus bar are connected. The pack case includes a cell accommodating space in which the plurality of cells are disposed and a junction box accommodating space in which the junction box is disposed. The harness assembly is configured to bundle voltage detection lines connected to the plurality of bus bars. The temperature sensor is disposed at a location near the refrigerant flow passage. The temperature detection cable extends from the temperature sensor toward the junction box accommodating space. The pack case includes a bottom wall and a pair of opposing side walls. The pair of side walls rise from the bottom wall. The cell accommodating space is disposed toward one end in a direction along the pair of side walls inside the pack case. The junction box accommodating space is disposed opposite the cell accommodating space in the direction along the pair of side walls inside the pack case. A harness assembly placement region in which the harness assembly is arranged is provided above the cell accommodating space. The first collective terminal is disposed at a first corner portion. The second collective terminal is disposed at a second corner portion defined by a second side wall of the pair of side walls and a side of the cell accommodating space that is far from the junction box accommodating space, the second side wall being opposite the first side wall. The first corner portion is defined by a first side wall of the pair of side walls and a side of the cell accommodating space that is close to the junction box accommodating space. The second corner portion is defined by a second side wall of the pair of side walls and a side of the cell accommodating space that is far from the junction box accommodating space, the side wall being opposite the first side wall. The first collective terminal bus bar extends from a location near the first corner portion toward the junction box. The second collective terminal bus bar extends from the second corner portion toward the junction box along the second side wall of the pair of side walls. The refrigerant flow passage is provided so as to pass the refrigerant through a predetermined path in the bottom wall. The temperature sensor is disposed at a position of a bottom wall that is away from a junction box accommodating space. A wiring route of the temperature detection cable is set so as to extend along the first side wall from a position at which the temperature sensor is disposed, while avoiding the harness assembly placement region within a region above the cell accommodating space. Also, the wiring route of the temperature detection cable is set so as to extend toward the junction box accommodating space while inwardly avoiding the first corner portion. Such a cell pack as described above is able to reduce concerns for the interference between the housed contents and wirings.

### BRIEF DESCRIPTION OF THE DRAWINGS

FIG. 1 is a perspective view of a cell pack 100.

FIG. 2 is a schematic plan view of the cell pack 100.

FIG. 3 is a perspective view of a cell 10.

FIG. 4 is a schematic view illustrating bus bar modules 30a to 30c.

FIG. 5 is a schematic view illustrating a portion at which a first collective terminal bus bar 37a is attached.

FIG. 6 is another schematic view illustrating the portion at which the first collective terminal bus bar 37a is attached.

FIG. 7 is still another schematic view illustrating the portion at which the first collective terminal bus bar 37a is attached.

### DETAILED DESCRIPTION

Hereinbelow, embodiments of the technology according to the present disclosure will be described with reference to the drawings. It should be noted, however, that the embodiments disclosed herein are, of course, not intended to limit the disclosure. The drawings are depicted schematically and do not necessarily accurately depict actual objects. The features and components that exhibit the same effects are designated by the same reference symbols as appropriate, and the description thereof will not be repeated as appropriate. In the following description, reference characters L, R, F, Rr, U and D in the drawings represent left, right, front, rear, up, and down, respectively. Reference characters X, Y, and Z in the drawings represent the lateral axis (shorter-side axis), the longer-side axis, and the heightwise axis of a cell pack, respectively. These directional terms are, however, merely provided for purposes in illustration. They are not intended to limit the arrangements and embodiments of the cells and the like in any way.

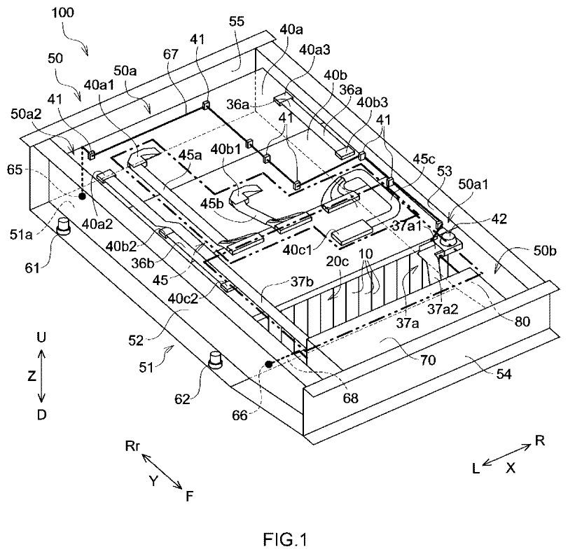

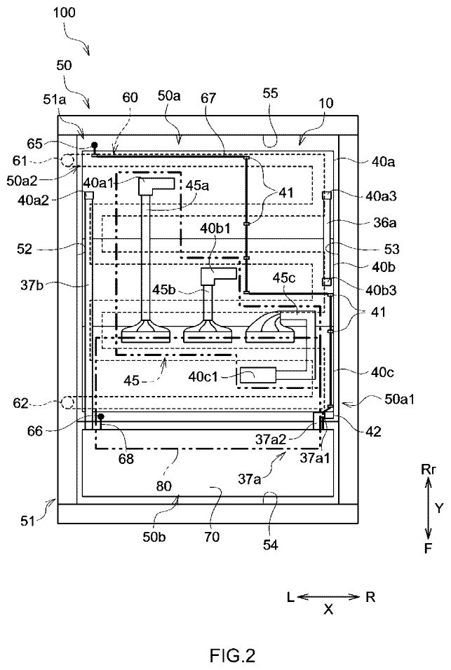

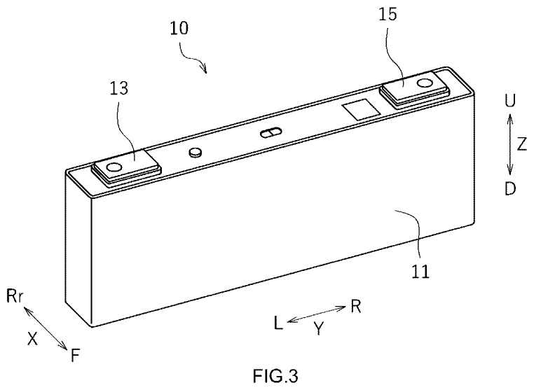

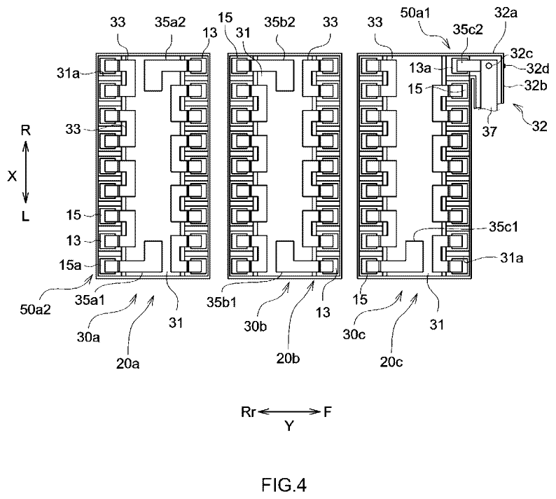

FIG. 1 is a perspective view of a cell pack 100. FIG. 2 is a schematic plan view of the cell pack 100. FIG. 3 is a perspective view of a cell 10. FIG. 4 is a schematic view illustrating bus bar modules 30a to 30c.

### Cell Pack 100

The cell pack 100 includes a plurality of cells 10, a plurality of bus bars 33, a first collective terminal bus bar 37a, a second collective terminal bus bar 37b, a junction box 70, a pack case 50, harness assemblies 45a to 45c, a refrigerant flow passage 60, a temperature sensor 65, and a temperature detection cable 67. Such a cell pack 100 has what is called a cell-to-pack structure, in which the plurality of cells 10 are disposed directly in the pack case 50. As illustrated in FIG. 1, in the cell pack 100, the plurality of cells 10 are disposed directly on a bottom wall 51 of the pack case 50.

### Plurality of Cells 10

Each of the plurality of cells 10 is an electricity storage device. As illustrated in FIG. 3, a cell 10 includes a case 11, a positive electrode terminal 13, and a negative electrode terminal 15. The case 11 is what is called a prismatic case, which is formed in a substantially rectangular parallelepiped shape. The inside of the case 11 houses an electrode body, which is not shown. The electrode body includes a positive electrode and a negative electrode. The positive electrode terminal 13 and the negative electrode terminal 15 are provided on respective side edge portions of the upper surface of the case 11. The positive electrode terminal 13 and the negative electrode terminal 15 are disposed spaced apart at a predetermined gap along a longitudinal axis Y of the cell 10. The positive electrode terminal 13 is electrically connected to the positive electrode of the electrode body, within the case 11. The negative electrode terminal 15 is electrically connected to the negative electrode of the electrode body, within the case 11. The configuration of the cell 10 may be the same as that of conventionally used electricity storage devices, so no further description is provided herein.

In the present description, the term “cell” refers to the smallest unit of the electricity storage device. The term “electricity storage device” refers to a device that is capable of repeated charging and discharging. The electricity storage device may include secondary batteries, such as lithium-ion secondary batteries and nickel-metal hydride batteries. The electricity storage device may also include capacitors, such as lithium-ion capacitors and electric double layer capacitors. The electricity storage device may use either an electrolyte solution or a solid electrolyte. For example, the electricity storage device may be either a secondary battery that uses what is called a liquid-type electrolyte solution, or what is called an all-solid-state battery.

### Pack Case 50

The pack case 50 is a case that houses the plurality of cells 10, the junction box 70, and so forth, as illustrated in FIG. 1. The pack case 50 is a housing that houses the constituent components that make up the cell pack 100. The pack case 50 may be, for example, made of metal, such as stainless steel, stainless steel alloys, aluminum, aluminum alloys, and the like. The pack case 50 includes a bottom wall 51 and side walls 52 to 55, and includes an internal space in a substantially rectangular shape.

The bottom wall 51 forms the bottom surface of the pack case 50. The bottom wall 51 is in a substantially rectangular shape. The side walls 52 to 55 are walls that rise from the respective side edges of the bottom wall 51. The side walls 52 to 55 may be provided with external connecting terminals or the like. The bottom wall 51 and the side walls 52 to 55 are firmly joined to each other so that required strength can be obtained. For the method of joining, it is possible to employ welding, bolts and nuts, structural adhesives, and the like. Although not shown in the drawings, a top lid that closes the internal space is attached to the pack case 50. Of the side walls 52 to 55, the side walls 52 and 53 are opposed to each other along a lateral axis X of the pack case 50. The side walls 54 and 55 are opposed to each other in a longitudinal axis Y of the pack case 50. In FIG. 1, front and rear are defined along the longitudinal axis Y, wherein “front” is toward the side wall 54 and “rear” is toward the side wall 55. In addition, left and right are defined along the lateral axis X as viewed from the front to the rear along the longitudinal axis Y, wherein “left” is toward the side wall 52 and “right” is toward the side wall 53.

The pack case 50 includes a cell accommodating space 50a and a junction box accommodating space 50b therein. The cell accommodating space 50a and the junction box accommodating space 50b are disposed opposite to each other with respect to a direction along the pair of side walls 52 and 53 within the pack case 50 (i.e., with respect to the longitudinal axis Y). In the embodiment shown in FIG. 1, the junction box accommodating space 50b is disposed toward the front inside the pack case 50 along the longitudinal axis Y of the pack case 50. The cell accommodating space 50a is provided in a portion inside the pack case 50 excluding the junction box accommodating space 50b. Herein, the junction box accommodating space 50b is the space in which the junction box 70 is to be disposed. The details of the junction box 70 will be described later.

### Cell Accommodating Space 50a

The cell accommodating space 50a is the space in which the plurality of cells 10 are to be disposed. The cell accommodating space 50a is provided within the pack case 50 toward one end in the direction along the pair of side walls 52 and 53 (frontward in this embodiment). In the embodiment shown in FIG. 1, three cell arrays 20a to 20c (see FIGS. 2 and 4) are provided in the cell accommodating space 50a, from the rear toward the front along the longitudinal axis Y. In each of the cell arrays 20a to 20c, a predetermined number of cells 10 are arrayed laterally in one row between the pair of side walls 52 and 53.

### Cell Arrays 20a to 20c

In each of the cell arrays 20a to 20c, cells 10 are arranged so that their respective positive electrode terminals 13 and negative electrode terminals 15 are alternately reversed. In other words, the positive electrode terminals 13 and the negative electrode terminals 15 are arranged alternately in the direction in which the cells 10 are arrayed. The gap between the pair of side walls 52 and 53 corresponds to the dimension of the plurality of cells 10 in the direction in which the pair of side walls 52 and 53 are opposed. The plurality of cells 10 are arrayed between the pair of side walls 52 and 53 so that almost no gap is formed between each other. The gap between the sides walls 52 and 53 and the length of the cell arrays 20a to 20c (i.e., the dimension in the stacking axis X of the cells) are substantially the same. The cells 10 contained in the cell arrays 20a to 20c are electrically connected by bus bar modules 30a to 30c in which bus bars 33 are provided.

In this embodiment, the number of cell arrays 20 provided in the cell accommodating space 50a and the number of the cells 10 contained in one cell array 20 are not limited to those shown in the embodiments herein unless specifically stated otherwise.

As illustrated in FIG. 2, the refrigerant flow passage 60 is provided in the bottom wall 51 of the pack case 50. The refrigerant flow passage 60 is provided so as to pass the refrigerant through a predetermined path in the bottom wall 51. In this embodiment, the refrigerant flow passage 60 is formed in a single flow passage so that the refrigerant can flow uniformly under the cell accommodating space 50a. In this embodiment, an inlet port 61 of the refrigerant is disposed at the rear of the pack case 50, and an outlet port 62 of the refrigerant is disposed in front of the pack case 50. Note that the positions of the inlet port 61 and the outlet port 62 of the refrigerant may be the other way round.

### Bus Bar Modules 30a to 30c

As illustrated in FIG. 4, the bus bar modules 30a to 30c include insulating plates 31, bus bars 33, and end bus bars 35a1 to 35c2.

### Insulating Plate 31

The insulating plate 31 is a plate-shaped member made of an electrically insulative resin material. The insulating plate 31 is in a substantially rectangular shape as viewed in plan. The insulating plate 31 covers the upper surfaces of the plurality of cells 10 contained in the cell arrays 20a to 20c. The insulating plate 31 is substantially parallel to the bottom wall 51. A plurality of openings 31a are formed in the insulating plate 31. The openings 31a are formed at positions that overlap the positive electrode terminals 13 and the negative electrode terminals 15 of the cells 10. The bus bars 33 are attached to the insulating plate 31 so as to close the plurality of openings 31a.

### Bus Bar 33

Each of the bus bars 33 is an electrically conductive member that connects a plurality of cells 10 in series. Each of the bus bars 33 connects the positive electrode terminal 13 of one of the plurality of cells 10 and the negative electrode terminal 15 of another one. For the bus bars 33, it is possible to use a highly electrically conductive metal, such as aluminum and copper. In the cell arrays 20a to 20c, the bus bars 33 connect the positive electrode terminals 13 and the negative electrode terminals 15 of adjacent cells 10. It is also possible that the plurality of cells 10 may include cells that are connected in parallel.

The shape of the bus bars 33 is not limited to any particular shape. In this embodiment, the bus bars 33 are substantially U-shaped. The intermediate portion of each of the bus bars 33 in substantially U-shape is mounted on the upper surface of the insulating plate 31. This allows the bus bars 33 to be held on the insulating plate 31. One end of a substantially U-shape bus bar 33 is connected to the positive electrode terminal 13 of a cell 10. The other end of the substantially U-shaped bus bar 33 is connected to the negative electrode terminal 15 of another cell 10 that is adjacent to that cell 10. The bus bars 33 may be connected to the positive electrode terminals 13 and the negative electrode terminals 15 by, for example, welding. A plurality of cells 10 are connected sequentially by the plurality of bus bars 33, so that the plurality of cells 10 are connected in series. The connection configuration of the cells 10 and the bus bars 33 is not limited to any particular configuration. In the cells 10 that are contained in the cell arrays 20a to 20c and disposed at opposite ends thereof, the positive electrode terminals 13 of the cells 10 at one end and the negative electrode terminals 15 of the cells 10 at the other end are each connected to one of the end bus bars 35a1 to 35c2.

### End Bus Bars 35a1 to 35c2

The end bus bars 35a1 to 35c2 are each an electrically conductive member for connecting one of the cell arrays 20a to 20c to another or to the junction box 70. For the end bus bars 35a1 to 35c2, it is possible to use a highly electrically conductive metal, such as aluminum and copper. The end bus bars 35a1 to 35c2 are mounted on the upper surface of the insulating plate 31.

In the bus bar module 30a attached to the cell array 20a, the end bus bar 35a1 is connected to the negative electrode terminal 15a of the left end cell 10. The end bus bar 35a2 is connected to the positive electrode terminal 13 of the right end cell 10 of the cell array 20a.

In the bus bar module 30b attached to the cell array 20b, the end bus bar 35b1 is connected to the positive electrode terminal 13 of the left end cell 10. The end bus bar 35b2 is connected to the negative electrode terminal 15 of the right end cell 10 of the cell array 20b.

In the bus bar module 30c attached to the cell array 20c, the end bus bar 35c1 is connected to the negative electrode terminal 15 of the left end cell 10. The end bus bar 35c2 is connected to the positive electrode terminal 13a of the right end cell 10 of the cell array 20c.

Here, the positive electrode terminal 13a of the right end cell 10 of the cell array 20c is an electrical terminal end of the plurality of cells 10 connected in series, which is also referred to as a collective terminal (a first collective terminal 13a herein). Likewise, the negative electrode terminal 15a of the left end cell 10 of the cell array 20a is an electrical terminal end of the plurality of cells 10 connected in series, which is also referred to as a collective terminal (a second collective terminal 15a herein). The first collective terminal 13a and the second collective terminal 15a have different polarities from each other. The plurality of cells 10 connected in series are connected to the junction box 70 by bus bars that are connected via the first collective terminal 13a and the second collective terminal 15a (i.e., by a first collective terminal bus bar 37a and a second collective terminal bus bar 37b).

### Inter-array Bus Bars 36a and 36b, First Collective Terminal Bus Bar 37a, Second Collective Terminal Bus Bar 37b

The cell arrays 20a to 20c (see FIG. 4) are electrically connected by inter-array bus bars 36a and 36b, as illustrated in FIG. 1. Herein, the inter-array bus bar 36a is connected to the end bus bar 35a2 of the cell array 20a and the end bus bar 35b2 of the cell array 20b (see FIGS. 1 and 4). The inter-array bus bar 36b is connected to the end bus bar 35b1 of the cell array 20b and the end bus bar 35c1 of the cell array 20c. Such inter-array bus bars 36a and 36b allow the cell arrays 20a to 20c to be connected in series. The positive electrode terminal 13a of the right end cell of the cell array 20c serves as the first collective terminal for the cell arrays 20a to 20c. The negative electrode terminal 15a of the left end cell of the cell array 20a serves as the second collective terminal for the cell arrays 20a to 20c. To the end bus bar 35c2, which is attached to the positive electrode terminal 13a of one end of the front-end cell array 20c, a first collective terminal bus bar 37a is attached. To the end bus bar 35a1, which is attached to the negative electrode terminal 15a of one end of the rear-end cell array 20a, a second collective terminal bus bar 37b is attached. This enables the voltage of the cell arrays 20a to 20c connected in series to be output by the first collective terminal bus bar 37a and the second collective terminal bus bar 37b.

In the cell pack 100, as illustrated in FIG. 2, the first collective terminal 13a is disposed at a corner portion (first corner portion 50a1) that is defined by the side wall 53 and a side of the cell accommodating space 50a that is close to the junction box accommodating space 50b. The second collective terminal 15a is disposed at a corner portion (second corner portion 50a2) that is defined by the side wall 52 and a side of the cell accommodating space 50a that is far from the junction box accommodating space 50b.

The bus bar modules 30a to 30c (see FIG. 4) may be placed on top of the cells 10 respectively for the cell arrays 20a to 20c (see FIG. 4), for example, after the plurality of cells 10 are placed in the pack case 50. The cells 10 contained in the cell arrays 20a to 20c are electrically connected to the bus bars 33 of the bus bar modules 30a to 30c, respectively. After the bus bar modules 30a to 30c are attached to the respective cell arrays 20a to 20c, covers 40a to 40c are attached to the bus bar modules 30a to 30c, respectively.

### Covers 40a to 40c

As illustrated in FIGS. 1 and 2, the covers 40a to 40c respectively cover the bus bar modules 30a to 30c disposed on top of the plurality of cells 10 in the cell arrays 20a to 20c. For this reason, the covers 40a to 40c are disposed on top of the plurality of cells 10. Each of the covers 40a to 40c has a substantially rectangular shape. The planar shape of each of the covers 40a to 40c is substantially the same as the outer shape of the insulating plate 31. The covers 40a to 40c are substantially parallel to the bottom wall 51. The covers 40a to 40c cover the upper surface of the insulating plate 31. The covers 40a to 40c cover the bus bars 33 and the end bus bars 35a1 to 35c2, which are fitted on the upper surface of the insulating plate 31. Therefore, the bus bars 33 and the end bus bars 35a1 to 35c2 are unlikely to interfere with the housed contents and wires inside the pack case 50.

The covers 40a to 40c are provided with lead-out ports 40a1, 40b1, and 40c1, respectively, for leading out harness assemblies 45a to 45c, which contain voltage detection cables connected to the bus bars of the cells 10. In addition, the upper portion of the covers 40a to 40c are provided with lead-in ports 40a2, 40a3, 40b2, 40b3, and 40c2, which respectively lead in the inter-array bus bars 36a and 36b and the first collective terminal bus bar 37a. The lead-in ports 40a2, 40a3, 40b2, 40b3, and 40c2 are disposed closer to respective opposite lateral sides. The lead-in ports 40a2, 40a3, 40b2, 40b3, and 40c2 have such a structure as to be able to open and close so that the inter-array bus bars 36a and 36b and the first collective terminal bus bar 37a can be fitted after the covers 40a to 40c have been fitted respectively to the cell arrays 20a to 20c. In addition, a plurality of retainers 41 for retaining a later-described temperature detection cable 67 are provided on top of the covers 40a to 40c along the wiring route of the temperature detection cable 67. In this embodiment, each of the retainers 41 is a hook protruding from the upper surface of the covers 40a to 40c, onto which the temperature detection cable 67 is to be hooked. With respect to the lateral axis X, the retainers 41 are provided at a left end portion and a central portion of the cover 40a, at a central portion of the cover 40b, and at a right end portion of the cover 40c. The wiring route of the temperature detection cable 67, in which the retainers 41 are provided, will be described later.

### Bus Bar Module 30c and Cover 40c

The bus bar module 30c, which is disposed closer to the junction box accommodating space 50b, is provided with an insulating part 32 (see FIGS. 4 to 7). The insulating part 32 is a part that supports the first collective terminal bus bar 37a, which is disposed closer to the junction box accommodating space 50b. The cover 40c includes a collective terminal cover part 42 that covers a location at which the first collective terminal bus bar 37a is attached. The collective terminal cover part 42 has such a structure as to be capable of opening and closing at the time of fitting and removal of the first collective terminal bus bar 37a. The structures of the insulating part 32 and the collective terminal cover part 42 will be described in detail later.

### Harness Assemblies 45a to 45c

In the harness assemblies 45a to 45c, voltage detection cables connected to the bus bars of the cells 10 in the cell arrays 20a to 20c are bundled respectively for each of the bus bar modules 30a to 30c provided for the cell arrays 20a to 20c, and connectors are provided. The voltage detection cables of the harness assemblies 45a to 45c are grouped together in single bundles respectively between the insulating plates 31 and the covers 40a to 40c of the bus bar modules 30a to 30c. Above the cell accommodating space 50a, a harness assembly placement region 45 (see FIGS. 1 and 2) is provided. The harness assemblies 45a to 45c are disposed in the harness assembly placement region 45. The harness assembly placement region 45 is provided on top of the covers 40a to 40c. Above the cover 40a, the harness assembly placement region 45 is set in an area to the left of the center of the lateral axis X. Above the cover 40b, the harness assembly placement region 45 is set in an area that is at the center and to the left of the center of the lateral axis X. Above the cover 40c, the harness assembly placement region 45 is set in an area to the right of the center of the lateral axis X. Above a boundary portion between the cover 40b and the cover 40c, the harness assembly placement region 45 is set in an area excluding both opposite end portions of the lateral axis X.

The voltage detection cables of the harness assemblies 45a to 45c extend from the lead-out ports 40a1 to 40c1 upward of the covers 40a to 40c. The harness assemblies 45a to 45c are placed on the upper surfaces of the covers 40a to 40c so as to extend toward a circuit board unit 80. The harness assembly placement region 45 is adjacent to the circuit board unit 80 disposed on top of the covers 40a to 40c. The connectors of the harness assemblies 45a to 45c are connected to the circuit board unit 80. The harness assembly placement region 45 partially overlaps the circuit board unit 80 with respect to the vertical axis Z. The harness assemblies 45a to 45c are connected to the junction box 70 via the circuit board unit 80. Such a harness assembly placement region 45 is set in an area that is wide along the lateral axis at the central portion above the cell accommodating space 50a.

### Fitting of Inter-Array Bus Bars 36a and 36b

As illustrated in FIG. 1, the inter-array bus bars 36a and 36b are disposed above the cell accommodating space 50a and on the covers 40a to 40c, and so as to extend along the longitudinal axis Y along the side walls 52 and 53 at the opposite ends of the lateral axis X. The inter-array bus bars 36a and 36b are fitted after the covers 40a to 40c have been fitted to the cell arrays 20a to 20c. At that time, the lead-in ports 40a3, 40b2, 40b3, and 40c2 of the covers 40a to 40c are opened, so that the inter-array bus bars 36a and 36b are connected respectively.

### Fitting of Second Collective Terminal Bus Bar 37b

The second collective terminal bus bar 37b is fitted to the second collective terminal 15a of the rear-end cell array 20a that is far from the junction box accommodating space 50b. As illustrated in FIG. 1, the second collective terminal bus bar 37b is disposed above the covers 40a to 40c and to the left of the lateral axis X, so as to extend along the longitudinal axis Y along the side wall 52. The second collective terminal bus bar 37b may be fitted after the inter-array bus bar 36b has been fitted. In a region in which the inter-array bus bar 36b is disposed, the second collective terminal bus bar 37b is disposed so as to pass above the inter-array bus bar 36b. The second collective terminal bus bar 37b is connected to the junction box 70. Thus, the second collective terminal bus bar 37b extends toward the junction box 70 along the side wall 52 from a location near the second corner portion 50a2, which is defined toward the rear end that is far from the junction box accommodating space 50b.

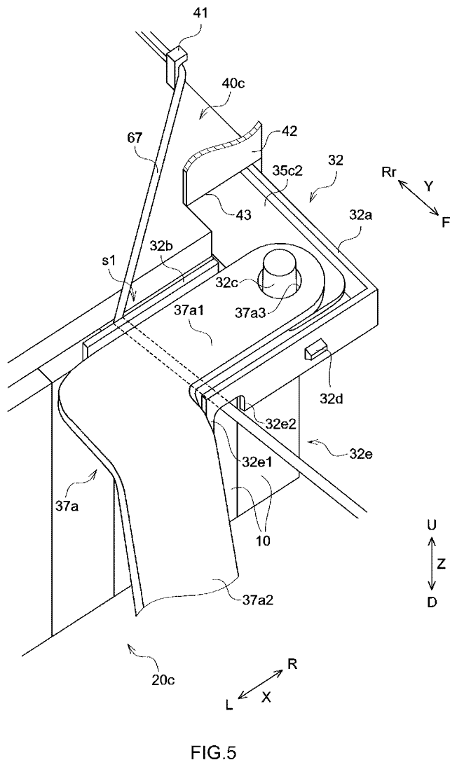

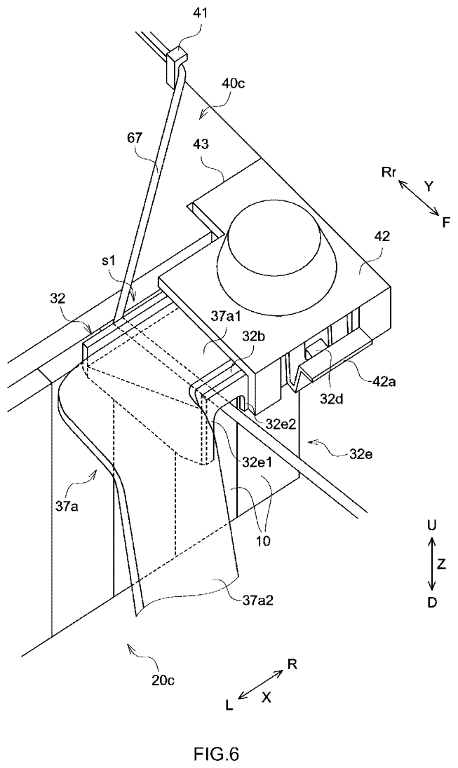

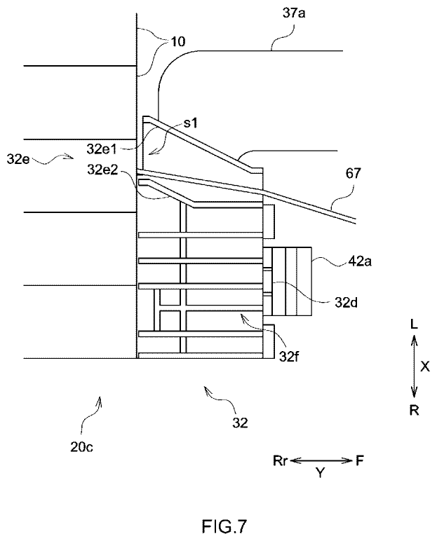

FIGS. 5 to 7 are schematic views illustrating a portion to which the first collective terminal bus bar 37a is attached. FIG. 5 shows a state in which the collective terminal cover part 42 is open. FIG. 6 shows a state in which the collective terminal cover part 42 is closed. FIG. 7 shows the portion at which the first collective terminal bus bar 37a is attached, as viewed from below. Hereinafter, the configuration of the portion at which the first collective terminal bus bar 37a is attached will be described along with the wiring procedure for the temperature detection cable 67.

### Fitting of First Collective Terminal Bus Bar 37a

As illustrated in FIGS. 1 and 2, the first collective terminal bus bar 37a extends from a location near the first corner portion 50a1 toward the junction box 70. In this embodiment, the end bus bar 35c2 (see FIG. 4), which serves as a connector to the first collective terminal bus bar 37a, is fitted to the first collective terminal 13a (see FIG. 4) disposed at the first corner portion 50a1. The first collective terminal bus bar 37a is connected to the end bus bar 35c2, to which the first collective terminal 13a is connected. The first collective terminal bus bar 37a is disposed on the opposite side to the second collective terminal bus bar 37b. The first collective terminal bus bar 37a is disposed on a right side of the cell pack 100. The first collective terminal bus bar 37a is substantially L-shaped. The first collective terminal bus bar 37a includes a portion 37a1 extending leftward from a location connected to the end bus bar 35c2, and a portion 37a2 extending frontward from that location. The frontward-extending portion 37a2 bends downward at an intermediate location, extends toward the junction box accommodating space 50b, and is connected to the junction box 70.

### Insulating Part 32

As illustrated in FIG. 5, the insulating part 32 is disposed below the first collective terminal bus bar 37a so as to extend from the insulating plate 31 (see FIG. 4) of the bus bar module 30c of the cell array 20. In this embodiment, the insulating part 32 is formed integrally with the insulating plate 31. Such an embodiment is merely exemplary, and it is also possible that the insulating part 32 may be formed separately from the insulating plate 31 or may be attached to the insulating plate 31. The insulating part 32 is disposed between the first collective terminal bus bar 37a and the bottom wall 51 of the pack case 50. The insulating part 32 includes a first portion 32a and a second portion 32b. The first portion 32a is a portion that extends frontward from the right front end of the insulating plate 31. The end bus bar 35c2 is disposed on the first portion 32a. The second portion 32b is a portion that extends from the front end of the first portion 32a laterally inward (leftward) of the cell pack 100 with a clearance gap s1 between it and the cell array 20c. A columnar protrusion 32c is provided at a boundary portion between the first portion 32a and the second portion 32b.

The end bus bar 35c2, connected to the first collective terminal 13a (see FIG. 4), is provided with a through hole (not shown) formed on the opposite side to the side that is connected to the first collective terminal 13a. The portion 37a1 of the first collective terminal bus bar 37a, which is connected to the end bus bar 35c2, is provided with a through hole 37a3 formed therein. The through hole of the end bus bar 35c2 and the through hole 37a3 of the first collective terminal bus bar 37 a are overlapped so that the protrusion 32c is inserted therethrough. This allows the end bus bar 35c2 and the first collective terminal bus bar 37a to be connected with them being positioned in place. The method of connecting the end bus bar 35c2 and the first collective terminal bus bar 37a is not limited to any particular method. The end bus bar 35c2 and the first collective terminal bus bar 37a may be connected by, for example, a bolt or the like. Thus, the first collective terminal bus bar 37a is disposed over the first portion 32a and the second portion 32b of the insulating part 32. The lower surface of the insulating part 32 is provided with a guide 32e for guiding a later-described temperature detection cable 67.

### Collective Terminal Cover Part 42

As illustrated in FIG. 6, the portion of the insulating part 32 to which the first collective terminal bus bar 37a is attached (the second portion 32b in this embodiment) may be covered by the collective terminal cover part 42. Like the insulating part 32, the collective terminal cover part 42 protrudes frontward from the right front end of the cover 40c. The collective terminal cover part 42 is continuous with the cover 40c. The collective terminal cover part 42 may be integrally formed with the cover 40c. In this embodiment, the collective terminal cover part 42 covers the first portion 32a and part of the second portion 32b of the insulating part 32. The collective terminal cover part 42 also covers the protrusion 32c disposed at the boundary portion between the first portion 32a and the second portion 32b. The collective terminal cover part 42 protects the connection between the first collective terminal bus bar 37a and the end bus bar 35c2. It also allows the first collective terminal bus bar 37a to be unlikely to interfere with other wirings.

The collective terminal cover part 42 is configured to be able to bend upward relative to the cover 40c. In other words, the collective terminal cover part 42 is configured to be able to open and close upward and downward, with a boundary 43 with the cover 40c being a pivot point. A protrusion 32d is provided at the front end of the insulating part 32, and an interlocking hook 42a that interlocks with the protrusion 32d is provided at the front end of the collective terminal cover part 42. The collective terminal cover part 42 may be retained on the insulating part 32 by the protrusion 32d and the interlocking hook 42a. After the end bus bar 35c2 and the first collective terminal bus bar 37a are connected to each other, the collective terminal cover part 42 is closed. Because the collective terminal cover part 42 is able to open and close, the connecting work of the first collective terminal bus bar 37a and the end bus bar 35c2 may be easier.

### Junction Box 70

The junction box 70 includes a protective circuit including relays and fuses that are electrically connected to the cell arrays 20a to 20c to control charging and discharging. The junction box 70 is electrically connected to the circuit board unit 80, and controls the protective circuit by control signals transmitted from the circuit board unit 80. Although not shown in the drawings in detail, the junction box 70 is connected to an external connecting terminal provided for the pack case 50. As illustrated in FIGS. 1 and 2, the junction box 70 is disposed in the junction box accommodating space 50b, which is disposed in a front part of the pack case 50.

### Temperature Sensors 65 and 66

Temperature sensors 65 and 66 are attached to the bottom wall 51 to detect the temperature of a location near the refrigerant flow passage 60. The temperature sensors 65 and 66 may be, but are not particularly limited to, thermistors, thermocouples, or the like. In this embodiment, thermistors are used as the temperature sensors 65 and 66. The temperature sensor 65 is disposed at a location near the inlet port 61 of the refrigerant flow passage 60. The temperature sensor 66 is disposed at a location near the outlet port 62 of the refrigerant flow passage 60. When the plurality of cells 10 generate heat due to use of the cell pack 100, the temperature of the refrigerant circulating inside the bottom wall 51 increases, which may cause a difference between the temperature on the inlet port 61 side and the temperature on the outlet port 62 side. Therefore, it is possible to detect a heat generation condition of the plurality of cells 10 by comparing the temperature on the inlet port 61 side detected by the temperature sensor 65 and the temperature on the outlet port 62 side detected by the temperature sensor 66. The temperature sensor 66 is attached at a location near the boundary between the cell accommodating space 50a and the junction box accommodating space 50b. In this embodiment, the temperature sensor 66 is connected to the circuit board unit 80 by a temperature detection cable 68 that passes through the junction box accommodating space 50b. Herein, the temperature sensor 66 is disposed at a location near the junction box accommodating space 50b. The temperature detection cable 68 is wired from the temperature sensor 66 toward the junction box accommodating space 50b, disposed in front, and thereafter is connected to the circuit board unit 80.

On the other hand, the temperature sensor 65 is disposed at a position of the bottom wall 51 that is away from the junction box accommodating space 50b. The temperature sensor 65 is disposed opposite the junction box 70 across the plurality of cells 10. The temperature sensor 65 is attached further rearward than the cell array 20a (see FIG. 4), the rearmost cell array, in a rear portion 51a of the bottom wall 51. The temperature sensor 65 is attached to a location near the side wall 55. The temperature sensor 65 is connected to the circuit board unit 80 by the temperature detection cable 67 that passes through the junction box accommodating space 50b. The temperature detection cable 67 may be bent, for example, so as to change its direction within the junction box 70, and connected to the circuit board unit 80. This allows the temperature detection cable 67 to be unlikely to interfere with other housed contents in the pack case 50, such as harness assemblies 45a to 45c. It should be noted that the temperature detection cable 67 that is bent within the junction box 70 is not shown in FIGS. 1 and 2.

### Temperature Detection Cable 67

The temperature detection cable 67 extends from the temperature sensor 65 toward the junction box accommodating space 50b. The temperature sensor 65 is disposed at a location of the bottom wall 51 that is on the side away from the junction box accommodating space 50b and is closer to the left end on which the second collective terminal bus bar 37b is disposed. The temperature detection cable 67 needs to be connected to the circuit board unit 80 after it is bent within the junction box 70. However, the plurality of cells 10 are disposed almost without gaps in the cell accommodating space 50a. This means that the cell accommodating space 50a has no gap space in which the temperature detection cable 67 is wired. Moreover, above the cell accommodating space 50a, the inter-array bus bars 36a and 36b, the first collective terminal bus bar 37a, and the second collective terminal bus bar 37b are disposed along the left and right side walls 52 and 53. This means that there is no gap space for the temperature detection cable 67 to be wired frontward simply along the left and right side walls 52 and 53. Furthermore, the harness assembly placement region 45 is provided at a central portion above the cell accommodating space 50a. There is also no gap space for wiring the temperature detection cable 67 also in the central portion above the cell accommodating space 50a. Because of such circumstances, an ingenious idea is necessary to accommodate and wire the temperature detection cable 67 within a region inside the pack case 50 of the cell pack 100.

In this embodiment, the temperature detection cable 67 is wired along a predetermined wiring route, as illustrated in FIGS. 1 and 2. The temperature detection cable 67 passes outside (above) the covers 40a to 40c. Note that the temperature detection cable 67 is retained by the retainers 41 that are disposed along the wiring route above the covers 40a to 40c. Herein, as described above, the temperature sensor 65 is disposed at a location of the bottom wall 51 that is on the side away from the junction box accommodating space 50b and is closer to the left end on which the second collective terminal bus bar 37b is disposed. First, the temperature detection cable 67 is wired from the temperature sensor 65 along the height axis of the cells 10 of the cell array 20a. Next, the temperature detection cable 67 is wired along the side wall 55 on the upper surface of the cover 40a along the lateral axis X. Then, the temperature detection cable 67 is wired frontward along the covers 40a and 40b from a laterally middle position of the pack case 50 so as to avoid the lead-out ports 40a1 and 40b1, through which the harness assemblies 45a and 45b of the cell arrays 20a and 20b are led out. Next, the temperature detection cable 67 is wired in a lateral direction toward the side wall 53 on the right side at a position such as to avoid the harness assembly placement region 45 and the inter-array bus bar 36a on the right side. Then, the temperature detection cable 67 is wired frontward along the side wall 53 on the right side to the position such as not to interfere with the collective terminal cover part 42, which is provided on the cover 40c of the cell array 20c. Thereafter, the temperature detection cable 67 is wired from a location along the side wall 53 so as to avoid the collective terminal cover part 42. Thereafter, the temperature detection cable 67 is wired so as to extend from the inside of the collective terminal cover part 42, pass under the first collective terminal bus bar 37a, and extend toward the junction box accommodating space 50b. The temperature detection cable 67 and the first collective terminal bus bar 37a intersect each other in the vertical axis Z.

In this embodiment, the temperature detection cable 67 is passed under the insulating part 32 of the insulating plate 31 of the bus bar module 30c of the cell array 20c, which is disposed below the first collective terminal bus bar 37a. In other words, the temperature detection cable 67 passes between the insulating part 32 and the bottom wall 51.

As illustrated in FIGS. 6 and 7, the insulating part 32 is provided with clearance gap s1 between it and the cell array 20c, and the temperature detection cable 67 is passed through such a clearance gap s1. The insulating part 32 includes a guide 32e on its lower surface. The guide 32e includes a pair of guide portions 32e1 and 32e2. The pair of guide portions 32e1 and 32e2 are disposed at positions sandwiching the temperature detection cable 67. The temperature detection cable 67 may be guided by a guide (the pair of guide portions 32e1 and 32e2 in this embodiment) provided on the lower surface of the insulating part 32. The provision of the guide allows the wiring route of the temperature detection cable 67 to be more stable and easily prevents the temperature detection cable 67 from interfering with the housed contents inside.

Herein, the pair of guide portions 32e1 and 32e2 extend downward from the lower surface of the insulating part 32. The temperature detection cable 67 passes between the pair of guide portions 32e1 and 32e2 and extends substantially frontward. Each of the pair of guide portions 32e1 and 32e2 extends downward from the insulating part 32. One of the guide portions, the guide portion 32e1, is disposed closer to the first collective terminal bus bar 37a that extends toward the junction box 70 (the junction box accommodating space 50b), i.e., closer to the portion 37a2, which extends frontward. The temperature detection cable 67 is guided by the guide portion 32e1, which extends downward, and is therefore unlikely to interfere with the first collective terminal bus bar 37a, which extends toward the junction box 70. Thus, the temperature detection cable 67 is guided by the guide portions 32e1 and 32e2 in the insulating part 32, which is provided below the first collective terminal bus bar 37a. This allows the temperature detection cable 67 to be wired easily and also prevents the position of the temperature detection cable 67 from being misaligned. Even when opening and closing the collective terminal cover part 42 for reconnection or replacement of the first collective terminal bus bar 37a below the first collective terminal bus bar 37a, it is unnecessary to move the temperature detection cable 67, resulting in good workability.

In the above-described embodiment, the cell pack 100 includes the plurality of cells 10, the plurality of bus bars 33, the first collective terminal bus bar 37a, the second collective terminal bus bar 37b, the junction box 70, the pack case 50, the harness assemblies 45a to 45c, the refrigerant flow passage 60, the temperature sensor 65, and the temperature detection cable 67. The harness assemblies 45a to 45c are disposed above the cell accommodating space 50a. The first collective terminal bus bar 37a extends from a location near the first corner portion 50a1 toward the junction box 70. The second collective terminal bus bar 37b extends from the second corner portion 50a2 toward the junction box 70 along the side wall 52. The temperature sensor 65 is disposed at a position of the bottom wall 51 that is away from the junction box accommodating space 50b. Herein, the wiring route of the temperature detection cable 67 is set so as to extend from the position at which the temperature sensor 65 is disposed, along one of the side walls, the side wall 53, in a region above the cell accommodating space 50a while avoiding the harness assemblies 45a to 45c, and toward the junction box accommodating space 50b while inwardly avoiding the first corner portion 50a1.

In such a cell pack 100, the temperature detection cable 67 of the temperature sensor 65, which is disposed to the rear of the pack case 50, extends along the side wall 53. Also, the temperature detection cable 67 extends toward the junction box accommodating space 50b, inwardly avoiding the first corner portion 50a1. For this reason, the temperature detection cable 67 is unlikely to interfere with other housed contents, wires, and the like that are provided inside the pack case 50.

The temperature sensor 65 is disposed opposite the junction box 70 across the plurality of cells 10. Even when the temperature sensor 65 and the junction box 70 are far apart, the temperature detection cable 67 is unlikely to interfere with the housed contents and wires inside the pack case 50 because of the above-described configuration. Moreover, because the temperature detection cable 67 is unlikely to interfere with the housed contents, wires, and the like, the safety of wiring work inside the pack case 50 may be improved.

The temperature detection cable 67 extends along the side wall 53, avoiding the harness assemblies 45a to 45c. This allows the harness assemblies 45a to 45c and the temperature detection cable 67 to be unlikely to interfere with each other.

In the above-described embodiment, the wiring route of the temperature detection cable 67 is set so as to avoid the first corner portion 50a1 inwardly (in a direction from the side wall 53 toward the side wall 52) and to thereafter pass between the plurality of cells 10 and the first collective terminal bus bar 37a and below the first collective terminal bus bar 37a. As a result, it is possible to wire the temperature detection cable 67 before connecting the first collective terminal bus bar 37a, to which a high voltage may be applied, to the junction box 70. This results in good workability in bending the temperature detection cable 67 in the junction box 70. In addition, the safety of wiring work may be improved because the first collective terminal bus bar 37a is not connected when wiring the temperature detection cable 67.

In this embodiment, in order to improve the safety of the cell pack 100 and the workability in wiring, an electrically insulative member (the insulating part 32 in this embodiment) is interposed between the first collective terminal bus bar 37a and the temperature detection cable 67. Herein, the electrically insulative member is composed of the insulating plate 31 of the bus bar module 30c of the cell array 20c. It is also possible that an electrically insulative member that is provided separately from the insulating plate 31 may be interposed between the first collective terminal bus bar 37a and the temperature detection cable 67. In addition, the above-described configuration is not necessarily employed when other means are used to electrically insulate and retain the temperature detection cable 67 on the wiring route.

In the above-described embodiment, the first collective terminal bus bar 37a includes a portion extending along the guide portion 32e1, which is one of the guide portions 32e1 and 32e2. As illustrated in FIG. 6, the portion 37a2 of the first collective terminal bus bar 37a extends downward along the guide portion 32e1. Because the guide portion 32e1 is interposed, the temperature detection cable 67 and the first collective terminal bus bar 37a are unlikely to interfere with each other even when connecting the first collective terminal bus bar 37a to the junction box 70.

In the above-described embodiment, the temperature detection cable 67 is wired from a location along the side wall 53 so as to avoid the collective terminal cover part 42. This allows the temperature detection cable 67 and the collective terminal cover part 42 to be unlikely to interfere with each other when opening and closing the collective terminal cover part 42. For example, when opening the collective terminal cover part 42, the collective terminal cover part 42 is easily interposed between the location at which the first collective terminal bus bar 37a is removed and the temperature detection cable 67. As a result, the safety in working may be improved when, for example, reconnecting the first collective terminal bus bar 37a and the like.

In addition, the insulating part 32 is disposed between the first collective terminal bus bar 37a and the bottom wall 51 of the pack case 50. The temperature detection cable 67 passes between the insulating part 32 and the bottom wall 51. This allows the temperature detection cable 67 to be unlikely to interfere with the first collective terminal bus bar 37a, which may further improve the safety of the cell pack 100.

As illustrated in FIG. 7, ribs 32f may be provided on the lower surface of the insulating part 32. The ribs 32f extend downward from the lower surface of the insulating part 32. A plurality of ribs 32f are provided along the lateral axis X and the longitudinal axis Y. The provision of the ribs 32f may improve the strength of the insulating part 32.

In the above-described embodiment, the gap between the pair of side walls 52 and 53 corresponds to the dimension of the plurality of cells 10 in the direction in which the pair of side walls 52 and 53 are opposed. The temperature detection cable 67 is easily wired safely even in the cell pack 100 with a configuration in which there is almost no gap between the plurality of cells 10 and the side walls 52 and 53.

Various embodiments of the technology according to the present disclosure have been described hereinabove. Unless specifically stated otherwise, the embodiments described herein do not limit the scope of the present disclosure. It should be noted that various other modifications and alterations may be possible in the embodiments of the technology disclosed herein. In addition, the features, structures, or steps described herein may be omitted as appropriate, or may be combined in any suitable combinations, unless specifically stated otherwise. In addition, the present description includes the disclosure as set forth in the following items.

### Item 1

A cell pack including:
a plurality of cells each including an electricity storage device;
a plurality of bus bars connecting the plurality of cells in series;
a first collective terminal bus bar connected to a first collective terminal being an electrical terminal end of the plurality of cells connected in series;
a second collective terminal bus bar connected to a second collective terminal being an electrical terminal end of the plurality of cells connected in series;
a junction box to which the first collective terminal bus bar and the second collective terminal bus bar are connected;
a pack case including a cell accommodating space in which the plurality of cells are disposed and a junction box accommodating space in which the junction box is disposed;
a harness assembly bundling voltage detection lines connected to the plurality of bus bars;
a refrigerant flow passage;
a temperature sensor disposed near the refrigerant flow passage; and
a temperature detection cable extending from the temperature sensor toward the junction box accommodating space, wherein:
the pack case includes a bottom wall and a pair of opposing side walls rising from the bottom wall;
the cell accommodating space is disposed toward one end in a direction along the pair of side walls inside the pack case;
the junction box accommodating space is disposed opposite the cell accommodating space in the direction along the pair of side walls inside the pack case;
a harness assembly placement region in which the harness assembly is arranged is provided above the cell accommodating space;
the first collective terminal is disposed at a first corner portion defined by a first side wall of the pair of side walls and a side of the cell accommodating space that is close to the junction box accommodating space;
the second collective terminal is disposed at a second corner portion defined by a second side wall of the pair of side walls and a side of the cell accommodating space that is far from the junction box accommodating space, the second side wall being opposite the first side wall;
the first collective terminal bus bar extends from a location near the first corner portion toward the junction box;
the second collective terminal bus bar extends from the second corner portion toward the junction box along the second side wall of the pair of side walls;
the refrigerant flow passage is provided so as to pass a refrigerant through a predetermined path in the bottom wall;
the temperature sensor is disposed at a position of the bottom wall of the cell accommodating space, the position being away from the junction box accommodating space; and
the temperature detection cable is wired along a wiring route that is set so as to extend along the first side wall from a position at which the temperature sensor is disposed while avoiding the harness assembly placement region within a region above the cell accommodating space, and to extend toward the junction box accommodating space while inwardly avoiding the first corner portion.

### Item 2

The cell pack according to item 1, wherein the temperature detection cable is wired along a wiring route that is set so as to pass between the cell accommodating space and the first collective terminal bus bar and below the first corner portion, after inwardly avoiding the first corner portion.

### Item 3

The cell pack according to item 1 or 2, further including:
an insulating part disposed between the first collective terminal bus bar and the bottom wall of the pack case; and wherein
the temperature detection cable passes between the insulating part and the bottom wall.

### Item 4

The cell pack according to item 3, wherein the insulating part includes a guide extending downward and disposed on a lower surface of the insulating part.

### Item 5

The cell pack according to item 4, wherein:
the guide includes a pair of guide portions such as to sandwich the temperature detection cable; and
the first collective terminal bus bar includes a portion thereof extending along one of the pair of guide portions.

### Item 6

The cell pack according to any one of items 1 through 5, further including:
a cover disposed above the plurality of cells, wherein:
the cover includes a collective terminal cover part covering at least a location at which the first collective terminal bus bar is attached;
the collective terminal cover part is configured to be openable and closable relative to the cover; and
the temperature detection cable extends from a location along the first side wall of the pack case so as to avoid the collective terminal cover part, and passes below the first collective terminal bus bar.

### Item 7

The cell pack according to item 6, wherein the temperature detection cable passes outside the cover.

### Item 8

The cell pack according to any one of items 1 through 7, wherein a gap between the pair of side walls of the pack case corresponds to a dimension of the plurality of cells in a direction in which the pair of side walls are opposed.

What is claimed is:

1. A cell pack comprising:
a plurality of cells each including an electricity storage device;
a plurality of bus bars connecting the plurality of cells in series;
a first collective terminal bus bar connected to a first collective terminal being an electrical terminal end of the plurality of cells connected in series;
a second collective terminal bus bar connected to a second collective terminal being an electrical terminal end of the plurality of cells connected in series;
a junction box to which the first collective terminal bus bar and the second collective terminal bus bar are connected;
a pack case including a cell accommodating space in which the plurality of cells are disposed and a junction box accommodating space in which the junction box is disposed;
a harness assembly bundling voltage detection lines connected to the plurality of bus bars;
a refrigerant flow passage;
a temperature sensor disposed near the refrigerant flow passage; and
a temperature detection cable extending from the temperature sensor toward the junction box accommodating space, wherein:
the pack case includes a bottom wall and a pair of opposing side walls rising from the bottom wall;
the cell accommodating space is disposed toward one end in a direction along the pair of side walls inside the pack case;
the junction box accommodating space is disposed opposite the cell accommodating space in the direction along the pair of side walls inside the pack case;
a harness assembly placement region in which the harness assembly is arranged is provided above the cell accommodating space;
the first collective terminal is disposed at a first corner portion defined by a first side wall of the pair of side walls and a side of the cell accommodating space that is close to the junction box accommodating space;
the second collective terminal is disposed at a second corner portion defined by a second side wall of the pair of side walls and a side of the cell accommodating space that is far from the junction box accommodating space, the second side wall being opposite the first side wall;
the first collective terminal bus bar extends from a location near the first corner portion toward the junction box;
the second collective terminal bus bar extends from the second corner portion toward the junction box along the second side wall of the pair of side walls;
the refrigerant flow passage is provided so as to pass a refrigerant through a predetermined path in the bottom wall;
the temperature sensor is disposed at a position of the bottom wall of the cell accommodating space, the position being away from the junction box accommodating space; and
the temperature detection cable is wired along a wiring route that is set so as to extend along the first side wall from a position at which the temperature sensor is disposed while avoiding the harness assembly placement region within a region above the cell accommodating space, and to extend toward the junction box accommodating space while inwardly avoiding the first corner portion.

2. The cell pack according to claim 1, wherein the temperature detection cable is wired along a wiring route that is set so as to pass between the cell accommodating space and the first collective terminal bus bar and below the first corner portion, after inwardly avoiding the first corner portion.

3. The cell pack according to claim 1, further comprising:
an insulating part disposed between the first collective terminal bus bar and the bottom wall of the pack case; and wherein
the temperature detection cable passes between the insulating part and the bottom wall.

4. The cell pack according to claim 3, wherein the insulating part includes a guide extending downward and disposed on a lower surface of the insulating part.

5. The cell pack according to claim 4, wherein:
the guide includes a pair of guide portions such as to sandwich the temperature detection cable; and
the first collective terminal bus bar includes a portion thereof extending along one of the pair of guide portions.

6. The cell pack according to claim 1, further comprising:
a cover disposed above the plurality of cells, wherein:
the cover includes a collective terminal cover part covering at least a location at which the first collective terminal bus bar is attached;
the collective terminal cover part is configured to be openable and closable relative to the cover; and
the temperature detection cable extends from a location along the first side wall of the pack case so as to avoid the collective terminal cover part, and passes below the first collective terminal bus bar.

7. The cell pack according to claim 6, wherein the temperature detection cable passes outside the cover.

8. The cell pack according to claim 1, wherein a gap between the pair of side walls of the pack case corresponds to a dimension of the plurality of cells in a direction in which the pair of side walls are opposed.
